(19) United States
(12) Patent Application Publication
(10) Pub. No.: US 2009/0036038 A1
(43) Pub. Date: Feb. 5, 2009

(54) PROCESS FOR RESTORING THE LUSTER TO THE SURFACE OF FACTORY FINISHED WOODEN FLOORS

(75) Inventors: Michael G. Kramer, Springdale, AR (US); Richard B. Strickland, Springdale, AR (US); D. Wayne Lee, Springville, TN (US)

Correspondence Address: HUSCH BLACKWELL SANDERS LLP, 720 OLIVE STREET, SUITE 2400, ST. LOUIS, MO, 63101, US

(73) Assignee: ALTO U.S. INC., Springdale, AR (US)

(21) Appl. No.: 12/250,941

(22) Filed: Oct. 14, 2008

Related U.S. Application Data
(62) Division of application No. 10/907,605, filed on Apr. 7, 2005.

(51) Int. Cl. B24B 1/00; B23P 11/00; B05D 1/00

(52) U.S. Cl. 451/57; 451/59; 29/428; 427/401

(57) ABSTRACT

A floor abrading machine is used to abrade the surface of a factory finished wooden floor so the abraded surface may be recoated with a fresh coat of wooden floor finish. Abrasion of the surface provides anchor sites to achieve a strong bond between the pre-existing abraded finish and the fresh coat of wooden floor finish. The process requires abrading, not removing the factory finish down to bare wood, and recoating to restore the luster to a factory finished wooden floor. Conventional sanders remove the finish down to bare wood to refinish a wooden floor that has been installed and finished in place.

### CROSS REFERENCE TO RELATED APPLICATION

This Application is a Divisional Application of application Ser. No. 10/907,605 filed Apr. 7, 2005, said application being a non-provisional application. The disclosures of U.S. patent application Ser. No. 10/907,605 are incorporated herein by reference.

### BACKGROUND OF INVENTION

Many surface coverings, such as factory finished wooden floors, can contain a resilient, wear-resistant topcoat and one or more intermediate coats. The surface of the finish of factory finished wood flooring can become scuffed, scraped, or marred when subjected to foot traffic and wear from anything that can come into contact with the finish. As a result, the finish looses its luster and becomes unsightly.

Factory finished hardwood floors are a growing segment of the wood flooring industry. These floors have their finish applied in the factory as opposed to the traditional method of having a contractor finish the floor on-site after installation. Some factory finished flooring manufacturers, as a means of giving their product a competitive advantage over traditional wood floors finished on site, have incorporated wear-resistant particles, like aluminum oxide, into these factory applied finishes. The aluminum oxide in the finish allows factory finished floor manufacturers to provide long wear-through warranties. However, these warranties are limited to wear-through only, and do not cover the everyday scuffing, scraping, marring, scratching, etc. Problems of scuffing, scraping, marring and scratching still occur, necessitating some solution.

Various attempts by others have been made to develop ways to recoat and restore the luster to the finish of factory finished wood floors. For example, U.S. Pat. No. 6,663,467 is for a Process and Composition for Abrading Factory finished Floors. This prior art patent discloses an abrading composition that is applied to an area of floor, such as from a spray pump bottle. The wet floor is then either hand abraded with a pad in circular motion or gone over with a rotary buffing machine having a buffing pad.

Another attempt to recoat factory finished floors has been made by BonaKemi USA, Inc. of Aurora, Colo. The BonaKemi web site (www.bonakemi.com) advertises the Prep™ recoat adhesion system. The web site describes this product as a specially formulated recoat adhesion system for all types of polyurethane finished hardwood floors, including factory finished floors. According to this web site, the system conditions and prepares the existing finish to optimize adhesion of the new coat of finish.

Another attempt to recoat factory finished floors has been made by Basic Coatings of Des Moines, Iowa. The Basic Coatings website (www.basiccoatings.com) advertises the TyKote Dustless Recoating System as a product suitable for factory finished floors. Material from Basic Coatings describes the process as follows: The surface of the factory finished wooden floor is cleaned with Intensive Floor Treatment, another Basic product, followed by a clear water rinse and cleaning with Squeaky Cleaner, another Basic product. The TyKote bonding agent is then applied to the remaining floor finish and left to dry for an hour or so. Once the TyKote bonding agent is dry the wood floor finish can be applied. However, there is still a need for a better way to solve the problem of worn factory finished wooden floors.

The process of the present invention requires abrading of the finish of the factory finished wooden floor to create microscopic scratches therein to facilitate adhesion of the fresh finish of wood floor finish. The factory applied finish is not removed down to bare wood as would be the preferred prior art process for conventional wood floor surfaces that are installed and finished in place. However, on some badly worn factory finished floors portions of the topcoat or all of the topcoat and one or more intermediate coats are abraded to receive a fresh finish, using the process of the present invention.

Prior art wood floor refinishing procedures utilize buffing machines that are typically used with buffing pads and screens adhered to the buffing face. The screens are coated with an abrasive that functions to remove and/or abrade the floor finish. After screening is complete the floor is cleaned with a dry mop to pick up any remaining dust before recoating. In the industry, cleaning with a dry mop is sometimes referred to as “tacking”. However, in the case of factory finished wood floors, the buffing process using conventional techniques quickly damages the screens due to the action of the wear-resistant particles embedded in the factory applied finish which dulls the screen, rendering it ineffective. This, in turn, has required the constant replacement of screens when trying to restore factory finished wear-resistant floors.

It has now been discovered that a new apparatus and process can be used to abrade the factory applied finish which often incorporates wear-resistant particles such as aluminum oxide. First the floor surface is cleaned. Then the factory applied finish is abraded; not entirely removed from the factory finished wood floor as with some conventional refinishing procedures. A fresh coat of wood floor finish is then applied to the abraded factory finish of the factory finished wood floor. In this manner, the luster is restored to a factory finished wood floor. The present invention is an abrading and recoating process; whereas conventional wooden floors are often refinished down to bare wood. In some situations where the finish is not badly damaged, conventional wooden floors are not always sanded down to bare wood; instead only portions of the finish may be abraded.

### SUMMARY OF INVENTION

This invention is a portable floor abrading machine and a process to abrade the finish of a factory finished wood floor to recoat and restore the luster to the surface. The floor abrading machine uses a brush with abrasive impregnated filaments to abrade the surface of a factory finished wood floor. The abrasives are selected from the group including aluminum oxide, silicone carbide and mixtures thereof. The process imparts microscopic scratches in the factory applied finish to provide anchor sites to achieve a good bond between the pre-existing abraded finish and the new coat of wood floor finish. Conventional wood floor surfaces are refinished and sanded down to the bare wood. The present invention abrades and recoats but does not completely remove the factory applied finish of the factory finished wood floor. The abrading brush used in the present invention has radial filaments impregnated with abrasive particles. Most floors are slightly uneven, even installed factory finished floors, due to the uneven sub-floor or minor variances in the wood thickness and manufacturing tolerances. The floor unevenness will create “high spots” and “low spots” in the floor. Both of these conditions are a challenge when it is time to restore the luster to a factory finished floor. When the filaments of the abrading brush encounter “high spots” they bend so the finish on this portion of the floor is not abraded down to bare wood. In the case of “low spots”, the abrading brush is designed with filaments long enough to reach into and sufficiently abrade the finish in “low spots” that would be encountered on a typical floor. Conventional recoating processes which use a buffer and screens do not perform well on floors which contain “high spots” and “low spots”. When a buffer with a screen encounters a “high spot” on the floor, it tends to completely remove the finish of a factory finished wooden floor down to the bare wood. It is undesirable to abrade the finish down to bare wood on the “high spots” because the overall floor coloring no longer is uniform and may need to be restained. It is difficult and often impossible to restain an exposed “high spot” to match the rest of floor. Further it is time consuming and adds to the expense of the project. When a conventional buffer and screen encounters a “low spot” it is likely to pass right over the area without ever abrading the finish. Once the new top coat of finish is applied, it is unlikely that the finish will adhere properly to the under coat of finish in the area of the “low spot” because no abrasion has occurred to allow for a mechanical bond to take place between the two coats of finish.

Various types of conventional sanders may be used in this invention after being fitted with an abrading brush. These conventional machines with an abrading brush may be used to recoat and restore the luster to the surface of a factory finished wood floor including the following:

| Model | Source |
|---|---|
| EZ-8 | Clarke Division of ALTO U.S. Inc. in |
| | Springdale, Arkansas, U.S.A. |
| Handy 8 and Handy 8E | Quide S.A. |
| | Deva, Guipuzcoa, Spain |
| Scorpion and Libra | Künzle & Tasin S.p.A. |
| | Milano, Italy |
| | Künzle & Tasin U.S. Inc. |
| | Fort Lee, New Jersey, U.S.A. |
| Profit | Eugen Lägler GmbH |
| | Guglingen - Frauenzimmer, Germany |
| Standard 8 | Bonakemi AB |
| | Malmö, Spain |
| 506 | Galaxy Floor Sanding Machines |
| | Toronto, Ontario, Canada |
| 5L-8* | Essex Silver-Line Corp. |
| | Dracut, Massachusetts, U.S.A. |
| HT8-1.2* | Hire Technicians Group Ltd. |
| | Watford, Herts, United Kingdom |

*The machines denoted with an asterisk have two wheels and the machine tips back to raise the machine out of contact with the floor and tips forward to lower the machine into contact with the floor for sanding. The other machines listed above have a lever mechanism like the EZ-8 that raises the machine out of contact with the floor and lowers the machine into contact with the floor for sanding. Those skilled in the art are familiar with both of these designs, i.e. the lever mechanism and the tip forward design. The EZ-8 operates at about 1800 RPM; some of the other machines listed above operate at about 2800 RPM.

### BRIEF DESCRIPTION OF DRAWINGS

FIG. 1 is a perspective view of a floor abrading machine for restoring the luster to prefinished factory floors.

FIG. 2 is a right side elevation view of the floor abrading machine of FIG. 1 with the front cover in the open position exposing a floor abrading brush.

FIG. 3 is a perspective view of the left side of the floor abrading machine of FIG. 1 with the front cover in the open position exposing the floor abrading brush.

FIG. 4 is a front elevation view of the floor abrading machine of FIG. 1 with the front cover in the open position exposing the floor abrading brush.

FIG. 5 is a bottom perspective view of the floor abrading machine of FIG. 1.

FIG. 6 is a cross-section view of a tufted abrading brush.

FIG. 7 is a top perspective of a single tuft of filaments from the brush of FIG. 6.

### DETAILED DESCRIPTION

Factory finished wood flooring is currently offered by many manufacturers using a variety of different manufacturing techniques. One manufacturing technique involves a long production line described below. Multiple strips of bare wood are put on a long conveyor and run under a belt sander. A stain may then be applied to the bare wood after it has been sanded. After the stain is applied, hair like fibers (sometimes called “nibs” in the industry) may be raised up in the wood grain. The strips of stained wood with raised nibs are sometimes run through a stationary denibbing machine with an abrasive sanding brush (sometimes called “a denibbing brush” in the industry). The brush is run at low RPM's with a finer grit to remove the “nibs”. A base coat of wood sealer is then applied.

The base coat of sealer may raise additional nibs. Again, the strips of stained, sealed wood with raised nibs are sometimes run through another denibbing machine having a denibbing brush to knock down the nibs and sand off excess sealer without breaking through the base coat to bare wood. Contractor grade factory finished wooden floors may have several intermediate coats of finish and a topcoat. Higher quality factory finished wooden floors may have 10 or more intermediate coats of wood finish and a topcoat. The intermediate coats and topcoat are applied sequentially on one long conveyor. The first intermediate coat of finish is applied to the slats. The slats go under an ultra-violet cure lamp which causes cross-linking in the first intermediate coat of finish. After curing, the slats run through a stationary sander with denibbing brushes, but the purpose of this step is not to remove nibs. Instead the purpose is to abrade the surface of the first intermediate coat to achieve a good bond with the second intermediate coat. Subsequent intermediate coats go through the same steps: apply a coat of finish, cure and abrade. Finally comes the topcoat which runs under the cure lamp to harden the surface and achieve cross-linking. However, the topcoat of finish is not run through a stationary abrading machine like all the prior coats of finish.

The denibbing brushes currently used by prefinished floor manufacturers may be fabricated from DuPont “Tynex A” filaments. (Tynex is a trademark owned by DuPont for nylon filament often used in brushes.) These brush filaments are about 70% nylon and are impregnated with about 30% silicon carbide or aluminum oxide abrasive. Brush designs vary among different manufacturers. Some denibbing brushes have filaments that are 1″ to 1⅝″ long with a filament density of 100-110 filaments per square inch and a grit of 180. Makers of the denibbing brushes sometimes recommend that they be operated at 500-800 RPM with an optimal deflection of 0.030 to 0.045 inches.

Applicants have tested several types of abrading brushes and have determined that certain types of abrading brushes are suitable for use in the portable floor abrading machine of the present invention to abrade and recoat the surface to restore the luster to factory finished wooden floors after they have been installed and become worn. Applicant does not believe that denibbing brushes are currently used to abrade the topcoat of conventional factory finished wooden floors during the manufacturing process. In contrast, the present invention uses an abrading brush to abrade the topcoat after it has become worn.

The following characteristics have proven suitable for abrading the topcoat in the present invention:

| Filament Length | Filament Population | Down Force | Grit |
|---|---|---|---|
| ⅞″-1½″ | 60-120 per square | 4.75-6.25 | 160-220 |
| | inch of brush | lbs/lineal | |
| | surface | inch of | |
| | | brush length | |
| optimally 1″-1¼″ | optimally 90-95 | optimally | optimally |
| | | 5.0-5.25 | 180 |

The downward resultant force on the brush is enough to cause a slight bend or deflection in the filaments when the abrading machine is in operation. The filaments deflect about 1/32 to about 1/16 inch. The deflection avoids abrading all the finish off the high spots in the floor as will be discussed in greater length below. If the resultant force on the brush is increased, the filament length can be shortened or the filament population can be increased, or a combination of both. The adjustment of these parameters is required to achieve a slight deflection in the filaments when the machine is in operation. Some abrading brushes that can be used in the present invention have filaments that are arranged, more or less, evenly about the brush core; other suitable abrading brushes that can be used in the present invention have tufts of filaments that are positioned in holes in the brush core. The tufted design is more economical to produce, but both designs are suitable for use in the present invention.

This invention is an apparatus and method for restoring the luster to the finish of a worn factory finished wood floor that has been previously installed. Generally, for typical hardwood flooring, it has been standard practice to screen the wood floors prior to refinishing. However, the principal difficulty of restoring the luster to worn factory finished wood flooring is the ability to abrade the finish without ruining the screen. It is believed that the wear-resistant particles (i.e., aluminum oxide particles) present in the factory finished wood flooring damage the buffer screen quicker than the floor is being abraded. Wear-resistant particles that are believed to be used in factory finished wood flooring include, but are not limited to, aluminum oxide, carborundum, quartz, silica (sand), glass particles, glass beads, glass spheres (hollow and/or filled), plastic grits, silicon carbide, diamond dust (glass), hard plastics, reinforced polymers, organics, and the like, or mixtures thereof. A floor abrading brush with wear resistant particles imbedded in the filaments of the brush is suitable for use with a floor abrading machine of the present invention.

ALTO U.S. Inc. the assignee of the present patent application currently makes and sells various types of sanders for wooden floors including: the Super 7R™, a hand held edger that is used around the walls and in other hard to reach areas and larger floor sanders such as the FloorCrafter™ a professional grade belt sander, the 3DS™, a rotary type fine finish sander that uses pads, screens and paper sheets, the OBS 18™, an orbital sander that use sand paper sheets and screens, the American 8™ a drum type sander, and the EZ-8™ a drum type sander which can be rented at many of the Home Depot® stores around the country. Most of these sanders, including the EZ-8 have dust control systems. A removable sanding drum mounts on the drive shaft of the EZ-8 which is relatively easy to use compared to the other sanders listed above. In order to prove the concept of the present invention, a floor abrading brush was substituted for the sanding drum on the drive shaft of the EZ-8. The Operator's Manual and the Parts and Service Manual for the EZ-8 are attached hereto and are incorporated herein by reference.

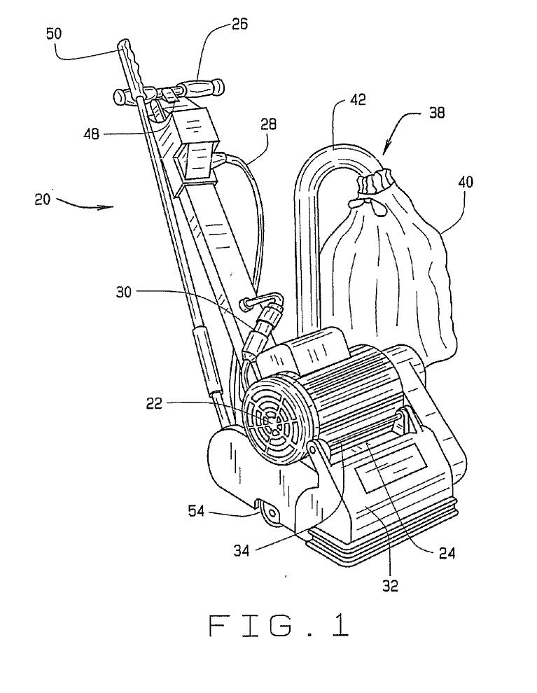

The following figures of the EZ-8 are described in general terms familiar to those in the floor sanding industry. FIG. 1 is a perspective view of a floor abrading machine generally identified by the numeral 20 that is suitable for restoring the luster to prefinished factory floors. A motor 22 is mounted on the frame 24. A removable handle 26 is also mounted on the frame. An electric cord 28 runs from the handle to the motor and includes a set of connectors 30 so the handle can be removed from the frame to facilitated storage and transport.

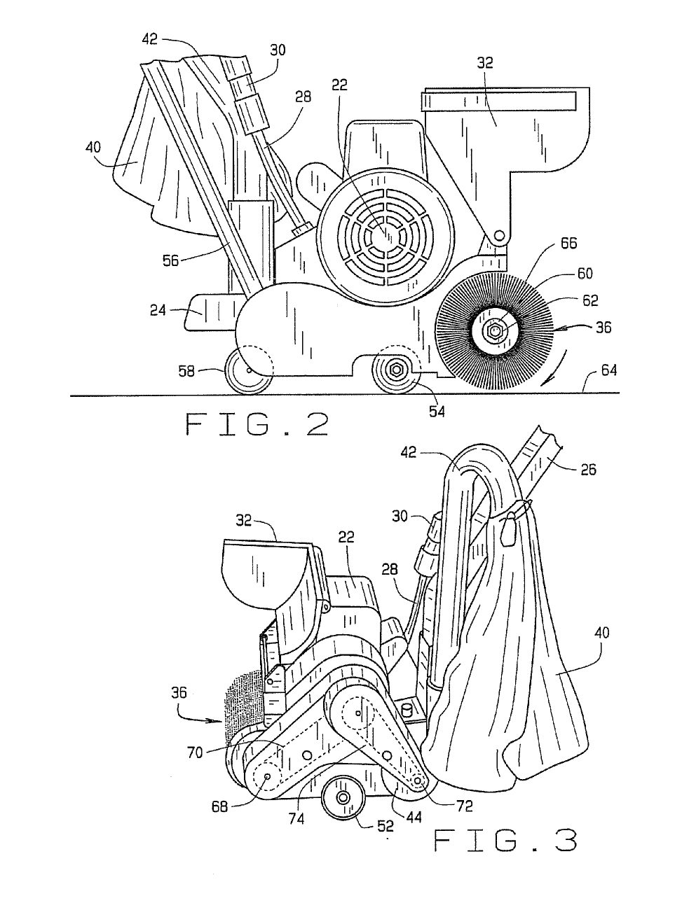

The front cover 32 is pivotally mounted on a shaft 34. The front cover has two positions. The lower position shown in FIG. 1 and the raised position shown in FIG. 2. The lower position is the operating position for abrading the floor. The raised position of FIG. 2 is to replace the removable floor abrading brush 36, better seen in FIG. 2.

While the floor abrading machine is in operation, dust is created during normal operation. This is also true of sanders, as anyone knows who has had a conventional wooden floor refinished in their home. Dust control systems are therefore common on sanders and will also be necessary on this floor abrading machine during normal operations. The dust control system is generally identified by the numeral 38 and includes a removable dust collection bag 40, a rotatable dust conduit 42, a vacuum fan 44, better seen in FIG. 5 and dust collection pan 46 also better seen in FIG. 5. The dust is collected in the pan, moves through the vacuum fan, through the dust conduit and into the dust collection bag. The dust in the bag should be emptied anytime the floor abrading machine is turned off because the dust can spontaneously combust. An on/off switch 48 is mounted on the handle. A power cord, not shown, connects on one end to the electric cord 28 and on the other end to a source of electricity, not shown to power the motor 22.

A lever 50 is used to simultaneously raise and lower the left wheel 52 and the right wheel 54, better seen in FIG. 5. A raising and lowering assembly, generally identified by the numeral 56 and better seen in FIG. 2 or FIG. 5 connects the lever 50 to the wheels 52, 54. A caster 58, better seen in the next figure is mounted on the rear of the frame 24. The position of the caster is fixed relative to the floor 64.

FIG. 2 is a right side elevation view of the floor abrading machine of FIG. 1 with the front cover 32 in the open position exposing a removable floor abrading brush 36. The brush mounts on a drive shaft 60 and is secured by a nut 62 which threadably engages the end of the drive shaft 60. To remove the brush, the nut is removed and the brush slips off the drive shaft. The motor 22 is operatively connected to the drive shaft 60; when the motor rotates, the drive shaft rotates and causes the brush to spin relative to the floor 64 in the direction of the arrow.

The wheels 52, 54 can be adjusted from a lower position as shown in FIG. 2 to a raised position, not shown. In the lower position, the wheels 52, 54 and the caster 58 keep the brush from engaging the floor 64. When the lever 50 is lowered, the raising and lowering assembly 56 retracts the wheels 52, 54 about ½ inch causing the brush to engage the floor 64. In order to abrade the floor 64, the wheels 52, 54 must be retracted. As previously mentioned, the position of the caster 58 is fixed relative to the floor and is not effected by actuation of the lever or the raising and lowering assembly 56.

The abrading brush 36 has a plurality of filaments 66 that radiate away from the center of the brush, as shown. The filaments 66 are impregnated with abrasive particles, such as aluminum oxide. Tynex A abrasive filaments from DuPont have proven to be suitable for this application. Denibbing brushes from The Industrial Brush Company, Inc. of Fairfield, N.J. have proven to be suitable for this application in 180 grit. Denibbing brushes from Malish Brush Company (www.malish.com) of Willoughby, Ohio may also be suitable. As the filament wears down, fresh abrasive is exposed to the floor because the abrasive is impregnated in the filament. Traditional sanding drums are not suitable for this application, because they encounter high spots in the floor and are likely to sand the finish all the way down to bare wood. This is undesirable because the exposed spot of bare wood may need to be restained. It is difficult and time consuming to stain a bare spot and make it look the same as the rest of the floor. Therefore, the brush with radial filaments is preferred over a drum design, because the filaments simply deform when a high spot in the floor is encountered. The brush is not as prone to abrade off all the finish to bare wood on high spots in the floor. The present invention is intended to only abrade the finish coat of a factory finished floor and not cut down to bare wood. In some situations, it is possible and even necessary on heavily worn floors for the present invention to completely remove the finish coat and one or more intervening layers of finish; however, on lightly worn floors, the goal is to abrade the finish coat only.

FIG. 3 is a perspective view of the left side of the floor abrading machine of FIG. 1 with the front cover 32 in the open position exposing the floor abrading brush generally identified by the numeral 36. The motor 22 has a drive shaft and a double pulley mounted thereon, not shown. A brush pulley 68, shown in phantom is connected to the brush drive shaft 60, not shown. A brush belt 70, also shown in phantom is operatively connected to the double pulley, not shown on the drive shaft of the motor, not shown. Thus when the motor rotates, the motor drive shaft, not shown, rotates and so does the double pulley, not shown, which rotates the brush belt 70 and the brush pulley 68, both shown in phantom, the drive shaft 60, better seen in the preceding figure and the brush 36.

A fan pulley 72, shown in phantom is connected to the fan drive shaft, not shown. A fan belt 74, also shown in phantom is operatively connected to the double pulley, not shown on the drive shaft of the motor, not shown. Thus when the motor rotates, the motor drive shaft, not shown, rotates and so does the double pulley, not shown, which rotates the fan belt 74 and the fan pulley 72, both shown in phantom and the vacuum fan 44.

The vacuum fan 44 creates a vacuum in the collection pan 46 to suck up the dust and abrasive particles. The dust moves and abrasive particles move from the collection pan 46, through the vacuum fan 44, the rotatable dust conduit 42 into the dust collection bag 40. As previously mentioned, the dust collection bag should be removed from the rotatable dust conduit to empty the dust when the machine is turned off.

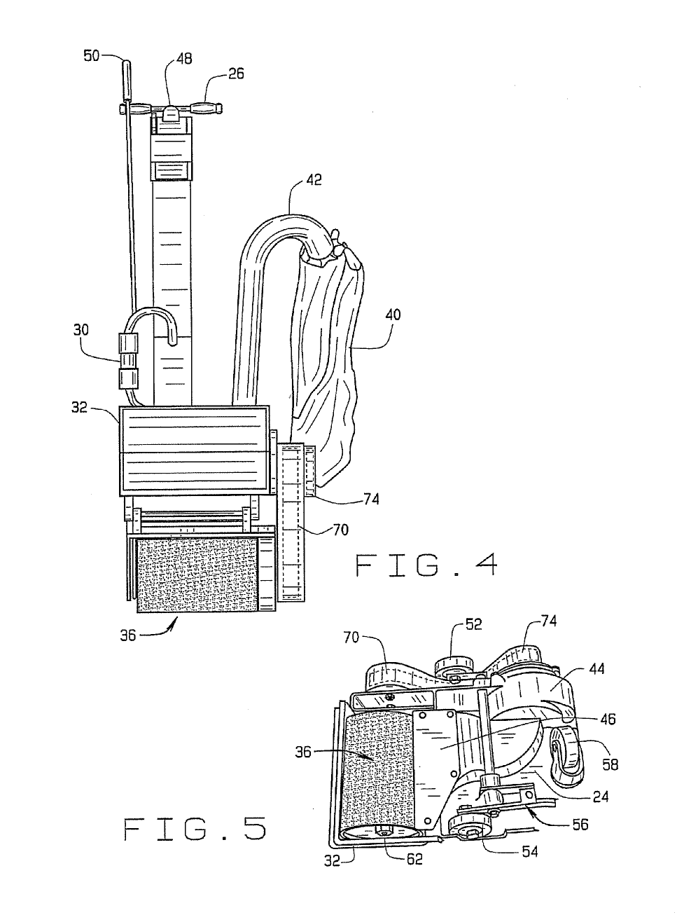

FIG. 4 is a front elevation view of the floor abrading machine of FIG. 1 with the front cover 32 in the open position exposing the floor abrading brush 36. The brush belt 70, shown in phantom drives the brush 36 as previously discussed. The dust and abrasive pass through the dust conduit 42 and are collected in the removable dust collection bag 40. The or/off switch 48 is positioned in a convenient location on the handle 26. The lever 50 raises and lowers the left wheel and the right wheel, not shown in this figure.

FIG. 5 is a bottom perspective view of the floor abrading machine of FIG. 1. As previously discussed the brush belt 70, shown in phantom drives the abrading brush 36 and the fan belt 74, shown in phantom drives the vacuum fan 44. When the floor abrading machine is in operation the vacuum fan creates a suction in the collection pan 46 which sucks up dust and abrasive particles which pass through the fan 44 and into the rotatable dust conduit 42 better seen in FIG. 4. The dust and abrasive particles come to rest in the dust collection bag 40 better seen in FIG. 4.

The frame 24 is raised and lowered by movement of the lever 50, better seen in the preceding figure. In FIG. 4, the lever 50 is shown in the upper position which raises the brush 36 out of contact with the floor 64. When the lever is lowered the raising and lowering assembly 56 retracts the wheels 52 and 54 about ½ inch which causes the frame 24 to lower to the floor thus engaging the filaments 66 of the brush 36 with the floor 64. The caster 58 is fixed and does not move up and down in response to actuation of the lever 50.

The floor cleaning process according to the present invention.

The surface of the factory finished wood floor is cleaned using any of a variety of procedures such as vacuuming with a soft brush to remove dirt and dust. Another cleaning procedure is to dry mop or “tack” the floor in addition to or in lieu of vacuuming. A light spray cleaner may also be applied to the dry mop to help pick up dust and dirt. The topcoat of the factory finished wooden floor is then abraded using the floor abrading machine described herein. If the topcoat is badly damaged or non-existent, one or more of the intermediate layers of finish may be abraded using the floor abrading machine. For purposes of claim interpretation, the word “surface” includes the topcoat and any intermediate coats of finish that may be necessary to abrade because of a badly damaged or non-existent topcoat; the term “surface” does not mean the wood of a factory finished wooden floor. The portions of the floor not abraded by the floor abrading machine are then abraded by hand using sand paper with aluminum oxide abrasive. The portions that have been done by hand are often referred to as “edges, “wall edges” or “wall lines” in the industry.

The abraded floor surface is then cleaned using any or all of the aforementioned procedures to remove dust and abrasive particles. A fresh coat of wooden floor finish is then applied to the abraded floor surface and allowed to dry, in accordance with the floor finish manufacturer's instructions, specific to each brand. After drying, the luster of the wooden floor has been restored and the floor is ready for use.

The abrading brush of the present invention is not suitable to refinish conventional wooden floors that are installed and sanded in place, rather than at the factory. If the present abrading brush is used on a conventional wooden floor to take the finish down to bare wood, the abrasive will wear away the soft wood and leave only the harder portions which results in an uneven floor surface. The present abrading brush should not be used with conventional techniques to refinish conventional wood floors that are finished in place. The present abrading brush is suitable for use to abrade the surface to restore the luster to worn factory finished floors. The filaments of the present abrading brush extend radially from the brush. Further, the filaments are flexible and deflect when they encounter peaks in the floor surface.

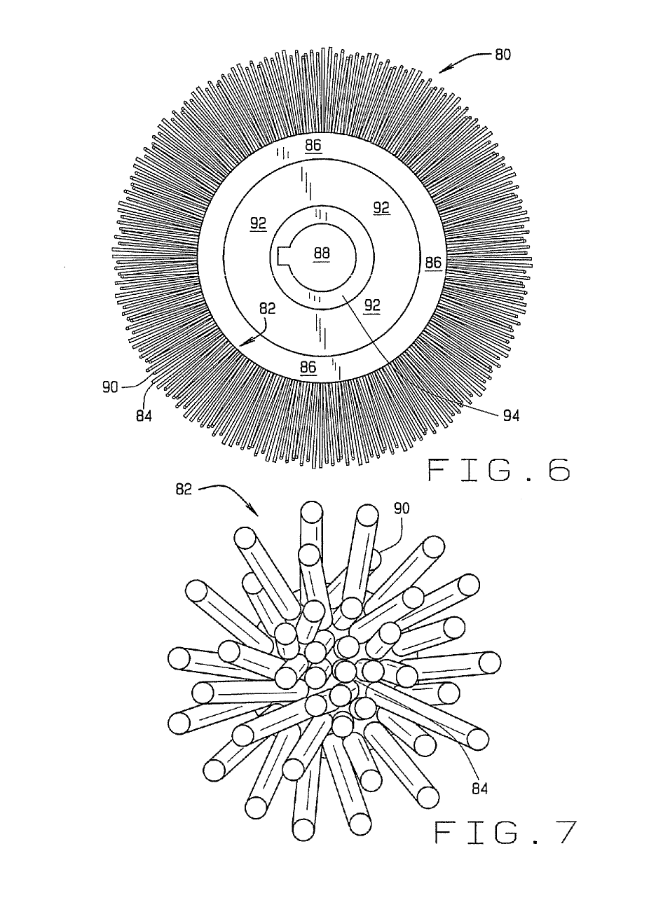

FIG. 6 is a cross-section view of a tufted abrading brush 80. A single tuft 82 consists of many filaments embedded in an outer core 86. A drum insert 92 is sized to fit inside the outer core. A counter bore 94 is formed in the drum insert 92.

FIG. 7 is a view of a single tuft 82 with multiple filaments 84 and 90 and other unnumbered filaments. An aperture 88 is formed in the center of the brush 80 and is sized to slip on the brush drive shaft 60. Some brush designs such as the one shown in FIG. 2 have a population of filaments more-or-less equidistant from the drive shaft 60. The brush in FIG. 6 has filaments that are not all equidistant from the drive shaft. For example, filament 84 is longer than filament 90. Both the design of FIG. 2 and the design of FIG. 6 have proved useful in the present invention, although the design of FIG. 6 may be more economical to produce than the design of FIG. 2.

FIG. 7 is a top perspective view of a single tuft identified by the numeral 82. The filaments are not equidistant from the center of the brush. For example, filament 84 is longer than filament 90.

1. A method for restoring the luster to the surface of an installed, factory finished wooden floor, using a portable floor abrading machine with a replaceable cylindrical brush with protruding filaments impregnated with abrasive particles comprising:
contacting the floor surface with the brush filaments to create an abraded substrate of finish to receive and bond with a fresh coat of wooden floor finish.

2. The method of claim 1 wherein the abrasive particles are about 160 grit to about 220 grit.

3. The method of claim 2 wherein the abrasive particles are optimally about 180 grit.

4. A method for restoring the luster to the surface of an installed, factory finished wooden floor, using a portable floor abrading machine with a replaceable cylindrical abrading brush with protruding filaments impregnated with aluminum oxide particles of about 180 grit comprising:
contacting the topcoat of an installed factory finished wooden floor with the brush filaments to improve the adhesion of a fresh coat of wooden floor finish to the abraded topcoat on the installed factory finished wooden floor.

5. A process for manufacturing a floor abrading machine for abrading the surface of an installed, factory finished wooden floor comprising:
mounting a motor, having a drive shaft, to a frame, wherein the frame includes a handle for moving the abrading machine about during operation;
attaching at least one rotatable wheel to the frame; and
attaching a cylindrical abrading brush with protruding filaments to the drive shaft,
wherein the protruding filaments are impregnated with an abrasive selected from the group consisting of silicon carbide, aluminum oxide and mixtures thereof.

6. A process for recoating the surface of an installed, factory finished wooden floor comprising the following steps:
cleaning the surface of the factory finished wooden floor;
abrading the surface of one section of the factory finished wooden floor using a portable floor abrading machine with a dust control system;
abrading the surface of another section of the factory finished wooden floor by hand;
cleaning the abraded surface of the factory finished wooden floor; and
applying a fresh coat of a wood floor finish to the clean, abraded surface of the installed, factory finished wooden floor.

7. A process for recoating the surface of a wear-resistant finish on an installed, factory finished wooden floor comprising the following steps:
abrading the surface of the wear-resistant finish of a portion of the factory factory finished wooden floor using a portable floor abrading machine;
abrading by hand other portions of the surface of the factory finished wooden floor that were not abraded by the portable floor abrading machine;
cleaning the abraded surface of the wear-resistant finish; and
applying a new finish to the abraded wear-resistant surface of the factory finished wooden floor.

8. The process of claim 7 wherein the first step is cleaning the surface of the wear-resistant finish of the factory finished wooden floor.

9. A process for restoring luster to the surface of an installed, factory finished wooden floor comprising the following steps:
scratching the surface of a portion of the factory finished wooden floor using a portable abrading machine;
scratching by hand other portions of the surface of the factory finished wooden floor that were not scratched by the portable abrading machine;
cleaning the scratched surface; and
applying wood floor finish to the clean, scratched surface of the factory finished wooden floor.

10. The process of claim 9 wherein the first step is cleaning the topcoat of the factory finished wooden floor.

11. A process for restoring luster to the surface of an installed, factory finished wooden floor comprising the following steps:
forming microscopic scratches in the surface of the wear-resistant finish of the factory finished wooden floor using a portable abrading machine for portions of the floor and by hand for other portions of the surface of the floor that were not abraded by the machine;
cleaning the scratched surface; and
applying wood floor finish to the clean, scratched surface of the factory finished wooden floor.

12. The process of claim 11 wherein the first step is cleaning the surface of the wear-resistant finish of the factory finished wooden floor.
